(19) United States
(12) Patent Application Publication
(10) Pub. No.: US 2020/0032875 A1
(43) Pub. Date: Jan. 30, 2020

(54) VIBRATION DAMPING DEVICE

(71) Applicant: AISIN AW CO., LTD., Anjo-shi, Aichi-ken (JP)

(72) Inventors: Yoichi OI, Ama, Aichi (JP); Takao SAKAMOTO, Anjo, Aichi (JP); Takuya FUKUOKA, Anjo, Aichi (JP); Kazuhiro ITOU, Anjo, Aichi (JP)

(73) Assignee: AISIN AW CO., LTD., Anjo-shi, Aichi-ken (JP)

(21) Appl. No.: 16/495,888

(22) PCT Filed: Apr. 27, 2018
(86) PCT No.: PCT/JP2018/017298

§ 371 Date: Sep. 20, 2019

(30) Foreign Application Priority Data
Apr. 28, 2017 (JP) 2017-089285
Jun. 30, 2017 (JP) 2017-129587

(51) Int. Cl. F16F 15/14; F02B 75/06; F16D 13/64; F16F 15/134; F16H 45/02

(52) U.S. Cl. CPC F16F 15/14; F02B 75/06; F16H 2045/0221; F16F 15/134; F16H 45/02; F16D 13/64

(57) ABSTRACT

A vibration damping device includes a supporting member rotatable about a rotation center of a rotating element, a restoring-force generating member coupled to the supporting member, and an inertial mass body coupled to the supporting member via the restoring-force generating member. The restoring-force generating member includes two guidable portions disposed with a clearance therebetween in a circumferential direction of the rotating element, and a torque transmission portion between the two guidable portions to transmit torque to and from the supporting member. The inertial mass body includes multiple guide portions for guiding corresponding guidable portions. When the supporting member rotates, the guidable portions transmit a component force of centrifugal force acting on the restoring-force generating member to the inertial mass body via the guide portions so the restoring-force generating member swings relative to the rotation center along a radial direction so that the inertial mass body swings about the rotation center.

### CROSS REFERENCE TO RELATED APPLICATIONS

This application is a National Stage of International Application No. PCT/JP2018/017298 filed Apr. 27, 2018, claiming priority based on Japanese Patent Application No. 2017-089285 filed Apr. 28, 2017 and Japanese Patent Application No. 2017-129587 filed Jun. 30, 2017.

### TECHNICAL FIELD

The present disclosure relates to a vibration damping device including a restoring-force generating member swingable along with rotation of a supporting member, and an inertial mass body that is coupled to the supporting member via the restoring-force generating member and that swings, synchronously with the restoring-force generating member, along with rotation of the supporting member.

### BACKGROUND ART

Conventionally, there is a known torque fluctuation suppression device that is used to suppress torque fluctuations in a rotating member for receiving torque input and that includes the following: a mass body that is rotatable with the rotating member and that is rotatably disposed relative to the rotating member; a centrifugal element that is radially movably disposed in a recess formed in the rotating member to receive centrifugal force due to rotation of the rotating member and the mass body; and a cam mechanism that receives the centrifugal force acting on the centrifugal element and that thereby rotates the rotating member and the mass body (refer to, for example, Patent Document 1). The cam mechanism of this torque fluctuation suppression device includes a cam follower provided to the centrifugal element, and a cam (an arc-shaped surface) formed on the inner circumferential surface of the rotating member or the mass body disposed radially outward such that the cam follower abuts with the cam. When a relative displacement occurs between the rotating member and the mass body in the direction of rotation, the cam mechanism converts the centrifugal force to a circumferential direction force in a direction that reduces the relative displacement. Using the centrifugal force acting on the centrifugal element as a force to suppress torque fluctuations in this way makes it possible to change torque-fluctuation suppression characteristics in accordance with the rotation speed of the rotating member.

### RELATED ART DOCUMENTS

### Patent Documents

Patent Document 1: Japanese Patent Application Publication No. 2017-40318 (JP 2017-40318 A)

### SUMMARY OF THE DISCLOSURE

The torque fluctuation suppression device disclosed in Patent Document can provide good vibration clamping performance when the order of the device is equal to the excitation order of an engine. Further, since a centrifugal element is radially movably disposed in a recess formed in a rotating member, a decrease in the order due to movement of the centrifugal element can be suppressed. However, the torque fluctuation suppression device disclosed in Patent Document 1 may fail to provide good vibration damping effect because a centrifugal force to be used as a force to suppress torque fluctuations may be damped by a friction force generated between the centrifugal element and the rotating member (the inner wall surface of the recess). In the torque fluctuation suppression device, the radial movement of the centrifugal element is guided by the rotating member. In this case, if a clearance between the recess of the rotating member and the centrifugal element is large, the friction force generated between the centrifugal element and the rotating member may be further increased due to rattling of the centrifugal element in the clearance. In contrast, if the clearance between the recess of the rotating member and the centrifugal element is too small, the friction force generated therebetween will also be increased. Moreover, if the centrifugal element digs into the inner wall surface of the recess and consequently becomes unable to swing relative to the rotating member, the torque fluctuation suppression device cannot provide vibration damping effect at all. In addition, in the torque fluctuation suppression device, a roller disposed on the outer circumferential surface of the centrifugal element or a projection formed unitarily with the centrifugal element is used as a cam follower of a cam mechanism. This may render the behavior of the centrifugal element unstable, particularly when the centrifugal element projects out of the recess in the rotating member, and tilting of the centrifugal element may cause a further increase in the friction force generated between the centrifugal element and the rotating member.

In view of the above, it is an aspect of the present disclosure is to further improve vibration damping performance of a vibration damping device including the following: a restoring-force generating member that swings along with rotation of a supporting member in a radial direction of the supporting member; and an inertial mass body that swings synchronously with the restoring-force generating member.

A vibration damping device according to the present disclosure includes the following: a supporting member that rotates integrally with a rotating element that receives torque transmitted from an engine about a rotation center of the rotating element; a restoring-force generating member that is coupled to the supporting member to transmit and receive the torque to and from the supporting member and that is swingable along a radial direction of the supporting member along with rotation of the supporting member; an inertial mass body that is coupled to the supporting member via the restoring-force generating member and that swings about the rotation center, synchronously with the restoring-force generating member, along with rotation of the supporting member; two guidable portions disposed in the restoring-force generating member with a clearance between the two guidable portions in a circumferential direction of the rotating element; a plurality of guide portions formed to the inertial mass body and configured to guide corresponding ones of the guidable portions, when the supporting member rotates, such that the restoring-force generating member swings relative to the rotation center along the radial direction and such that the inertial mass body swings about the rotation center, a component force of centrifugal force acting on the restoring-force generating member when the supporting member rotates being transmitted from the guidable portions to the guide portions; and a torque transmission portion disposed in the restoring-force generating member and located between the two guidable portions in the circumferential direction so as to transmit and receive the torque to and from the supporting member.

In the vibration damping device according to the present disclosure, when the supporting member rotates integrally with the rotating element, the guidable portions formed to the restoring-force generating member are guided by the guide portions formed to the inertial mass body, thereby causing the restoring-force generating member to swing along the radial direction of the supporting member. Further, when the supporting member rotates integrally with the rotating element, the component force of the centrifugal force acting on the restoring-force generating member is transmitted to the inertial mass body via the guidable portions and the guide portions, and the guidable portions are guided by the guide portions, thereby causing the inertial mass body to swing about the rotation center synchronously with the restoring-force generating member. This makes it possible to supply torque of opposite phase (inertia torque) to fluctuating torque transmitted from the engine to the rotating element, to the supporting member via the restoring-force generating member (the torque transmission portion), thus damping the vibration of the rotating element successfully. Further, the restoring-force generating member includes the two guidable portions disposed with a clearance therebetween in the circumferential direction of the rotating element, and movement of the restoring-force generating member is defined (restrained) by the two (a pair of) guidable portions and their corresponding two (a pair of) guide portions of the inertial mass body. This causes the pair of guidable portions and the pair of guide portions to restrict rotation of the restoring-force generating member about its own axis so as to suppress a decrease in the order of the vibration damping device due to the rotation of the restoring-force generating member about its own axis, and also causes the restoring-force generating member to smoothly swing relative to the supporting member so as to suppress damping of the centrifugal force (its component force), acting on the restoring-force generating member, to be used as a restoring force for swinging the inertial mass body. Further, defining (restraining) the movement of the restoring-force generating member by the pair of guidable portions and the pair of guide portions allows a reduction in friction force that is generated at the torque transmission portion during transmission and reception of the torque between the restoring-force generating member and the supporting member. Thus, it is possible to further improve vibration damping performance of the vibration damping device including the restoring-force generating member that swings in the radial direction of the supporting member along with rotation of the supporting member.

### BRIEF DESCRIPTION OF THE DRAWINGS

FIG. 1 is a simplified structure diagram of a starting apparatus including a vibration damping device according to the present disclosure.

FIG. 2 is a cross-sectional view of the starting apparatus illustrated in FIG. 1.

FIG. 3 is an enlarged view illustrating the vibration damping device according to the present disclosure.

FIG. 4 is an explanatory diagram illustrating a restoring-force generating member included in the vibration damping device according to the present disclosure.

FIG. 5 is an enlarged cross-sectional view illustrating a main part of the vibration damping device according to the present disclosure.

FIG. 6 is an enlarged cross-sectional view illustrating a main part of the vibration damping device according to the present disclosure.

FIG. 7 is an enlarged view illustrating the vibration damping device according to the present disclosure.

FIG. 8 is an enlarged view illustrating a vibration damping device according to a modification of the present disclosure.

FIG. 9 is an enlarged view illustrating another vibration damping device according to the present disclosure.

FIG. 10 is an enlarged cross-sectional view illustrating a main part of the other vibration damping device according to the present disclosure.

FIG. 11 is an enlarged cross-sectional view illustrating a main part of the other vibration damping device according to the present disclosure.

FIG. 12 is a simplified structure diagram illustrating a modification of a damper device including the vibration damping device according to the present disclosure.

FIG. 13 is a simplified structure diagram illustrating another modification of a damper device including the vibration damping device according to the present disclosure.

### DETAILED DESCRIPTION

Next, an embodiment of the present disclosure is described with reference to the drawings.

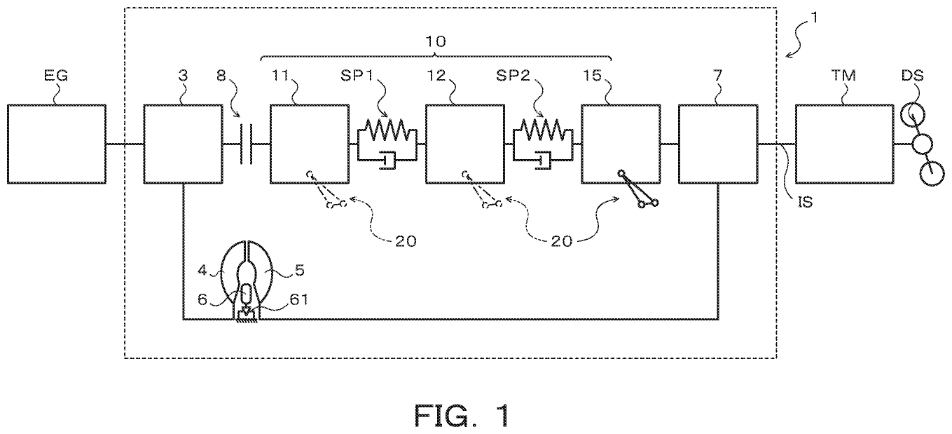

FIG. 1 is a simplified structure diagram of a starting apparatus 1 including a vibration damping device 20 according to the present disclosure. The starting apparatus 1 illustrated in the drawing is mounted on a vehicle equipped with, for example, an engine (an internal combustion engine) EG as a driving device so as to transmit power from the engine EG to a drive shaft DS of the vehicle. The starting apparatus 1 includes, in addition to the vibration damping device 20, the following: a front cover 3 as an input member that is coupled to a crankshaft of the engine EG; a pump impeller (an input-side fluid transmission element) 4 that is fixed to the front cover 3 and that rotates as a unit with the front cover 3; a turbine runner (an output-side fluid transmission element) 5 that is rotatable coaxially with the pump impeller 4; a damper hub 7 serving as an output member fixed to an input shaft IS of a transmission (a power transmission device) TM that is an automatic transmission (AT), a continuously variable transmission (Off), a dual clutch transmission (DCT), a hybrid transmission, or a speed reducer; a lockup clutch 8; and a damper device 10.

In the description below, unless specified otherwise, the term “axial direction” basically refers to the direction of extension of a center axis (an axis) of the starting apparatus 1 and the damper device 10 (the vibration damping device 20). Further, unless specified otherwise, the term “radial direction” basically refers to the radial direction of the starting apparatus 1, the damper device 10, and rotating elements of the damper device 10 and the like, i.e., refers to the direction of extension of a straight line that extends from the center axis of the starting apparatus 1 and the damper device 10 in directions (radial directions) perpendicular to the center axis. Furthermore, unless specified otherwise, the term “circumferential direction” basically refers to the circumferential direction of the starting apparatus 1, the damper device 10, and rotating elements of the damper device 10 and the like, i.e., refers to directions along the direction of rotation of the rotating elements.

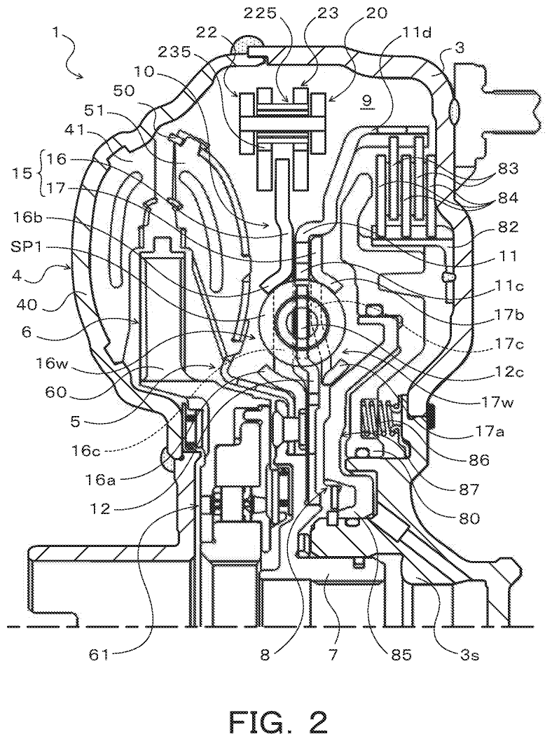

As illustrated in FIG. 2, the pump impeller 4 includes a pump shell 40 tightly fixed to the front cover 3, and multiple pump blades 41 that are disposed on the inner surface of the pump shell 40. As illustrated in FIG. 2, the turbine runner 5 includes a turbine shell 50 and multiple turbine blades 51 that are disposed on the inner surface of the turbine shell 50. An inner perimeter portion of the turbine shell 50 is fixed to the damper huh 7 via multiple rivets.

The pump impeller 4 and the turbine runner 5 face toward each other, and a stator 6 is coaxially located therebetween so as to straighten the flow of hydraulic oil (hydraulic fluid) from the turbine runner 5 to the pump impeller 4. The stator 6 has multiple stator blades 60, and the rotation direction of the stator 6 is set to only one direction by a one-way clutch 61. The pump impeller 4, the turbine runner 5, and the stator 6 form a torus (an annular flow passage) for circulating the hydraulic oil and serves as a torque converter (a fluid transmission device) with the function of amplifying torque. However, in the starting apparatus 1, the stator 6 and the one-way clutch 61 may be omitted, and the pump impeller 4 and the turbine runner 5 may be caused to function as a fluid coupling.

The lockup clutch 8 is structured as a hydraulic multi-plate clutch and performs lockup that couples the front cover 3 to the damper hub 7, i.e., the input shaft IS of the transmission TM, via the damper device 10, and also releases the lockup. The lockup clutch 8 includes the following: a lockup piston 80 that is movably supported in the axial direction by a center piece 3s fixed to the front cover 3; a drum portion 11d serving as a clutch drum that is integrated with a drive member 11 that is an input element of the damper device 10; an annular clutch hub 82 that is fixed to the inner surface of the front cover 3 in such a manner as to face the lockup piston 80; multiple first frictionally-engaging plates (friction plates each having a friction material on both sides) 83 that fit with splines formed on the inner circumferential surface of the drum portion 11d; and multiple second frictionally-engaging plates (separator plates) 84 that fit with splines formed on the outer circumferential surface of the clutch hub 82.

Further, the lockup clutch 8 includes the following: an annular flange member (an oil-chamber defining member) 85 that is attached to the center piece 3s of the front cover 3 and that is located on the opposite side of the lockup piston 80 from the front cover 3, i.e., located closer to the damper device 10 than the lockup piston 80; and multiple return springs 86 disposed between the front cover 3 and the lockup piston 80. As illustrated in the drawings, the lockup piston 80 and the flange member 85 define an engagement oil chamber 87. The engagement oil chamber 87 is supplied with hydraulic oil (engagement hydraulic pressure) from a hydraulic pressure control device, which is not illustrated. By increasing the engagement hydraulic pressure supplied to the engagement oil chamber 87, the lockup piston 80 is moved in the axial direction to press the first and second frictionally-engaging plates 83 and 84 toward the front cover 3, thus engaging (fully or slippingly engaging) the lockup clutch 8. The lockup clutch 8 may be structured as a hydraulic single-plate clutch.

The damper device 10, as illustrated in FIGS. 1 and 2, includes the following as rotating elements: the drive member (an input element) 11 including the drum portion 11d; an intermediate member (an intermediate element) 12; and a driven member (an output element) 15. Further, the damper device 10 includes, as torque transmission elements, multiple (according to the present embodiment, for example, four) first springs (first elastic bodies) SP1 and multiple (according to the present embodiment, for example, four) second springs (second elastic bodies) SP2 that are alternately disposed on the same circumference and that are spaced from each other in the circumferential direction. Arc coil springs and straight coil springs may be adopted as the first and second springs SP1 and SP2. The arc coil springs are made of a metal material and are wound in such a manner as to have an axis extending in an arc under no load. The straight coil springs are made of a metal material and are helically wound in such a manner as to have an axis extending linearly under no load. Further, as illustrated, so-called double springs may be adopted as the first and second springs SP1 and SP2.

The drive member 11 of the damper device 10 is an annular member including the drum portion 11d near its outer perimeter and has multiple (according to the present embodiment, for example, four spaced at intervals of 90 degrees) spring abutment portions 11.c that are spaced from each other in the circumferential direction and that extend inward in the radial direction from its inner perimeter portion. The intermediate member 12 is an annular plate member and has multiple (according to the present embodiment, for example, four spaced at intervals of 90 degrees) spring abutment portions 12c that are spaced from each other in the circumferential direction and that extend inward in the radial direction from its outer perimeter portion. The intermediate member 12 is rotatably supported by the damper hub 7 and is surrounded with the drive member 11 at a position inward from the drive member 11 in the radial direction.

The driven member 15 includes, as illustrated in FIG. 2, an annular first driven plate 16 and an annular second driven plate 17 that is coupled to the first driven plate 16 via multiple rivets that are not illustrated, in such a manner as to rotate as a unit with the first driven plate 16, The first driven plate 16 is structured as an annular plate member, is located closer to the turbine runner 5 than the second driven plate 17, and is fixed, together with the turbine shell 50 of the turbine runner 5, to the damper hub 7 via multiple rivets. The second driven plate 17 is structured as an annular plate member with an inside diameter smaller than that of the first driven plate 16, and an outer perimeter portion of the second driven plate 17 is fastened to the first driven plate 16 via multiple rivets that are not illustrated.

The first driven plate 16 includes the following: multiple (according to the present embodiment, for example, four) spring holding windows 16w that each extends in an arc and that are spaced from each other (at equal intervals) in the circumferential direction; multiple (according to the present embodiment, for example, four) spring supporting portions 16a that each extends along an inner circumferential edge of a corresponding one of the spring holding windows 16w and that are spaced from each other (at equal intervals) in the circumferential direction; multiple (according to the present embodiment, for example, four) spring supporting portions 16b, that each extends along an outer circumferential edge of a corresponding one of the spring holding windows 16w, that are spaced from each other (at equal intervals) in the circumferential direction, and that each faces a corresponding one of the spring supporting portions 16a in the radial direction of the first driven plate 16; and multiple (according to the present embodiment, for example, four) spring abutment portions 16c. The spring abutment portions 16c of the first driven plate 16 are each provided between a corresponding pair of circumferentially adjacent ones of the spring holding windows 16w (the spring supporting portions 16a and 16b).

The second driven plate 17 also includes the following: multiple (according to the present embodiment, for example, four) spring holding windows 17w that each extends in an arc and that are spaced from each other (at equal intervals) in the circumferential direction; multiple (according to the present embodiment, for example, four) spring supporting portions 17a that each extends along an inner circumferential edge of a corresponding one of the spring holding windows 17w and that are spaced from each other (at equal intervals) in the circumferential direction; multiple (according to the present embodiment, for example, four) spring supporting portions 17b, that each extends along an outer circumferential edge of a corresponding one of the spring holding windows 17w, that are spaced from each other (at equal intervals) in the circumferential direction, and that each faces a corresponding one of the spring supporting portions 17a in the radial direction of the second driven plate 17; and multiple (according to the present embodiment, for example, four) spring abutment portions 17c. The spring abutment portions 17c of the second driven plate 17 are each provided between a corresponding pair of circumferentially adjacent ones of the spring holding windows 17w (the spring supporting portions 17a and 17b). According to the present embodiment, as illustrated in FIG. 2, the drive member 11 is rotatably supported by an outer circumferential surface of the second driven plate 17 that is supported by the damper hub 7 via the first driven plate 16, and this causes the drive member 11 to align with the damper hub 7.

With the damper device 10 mounted, one of each of the first and second springs SP1 and SP2 is disposed between each pair of adjacent ones of the spring abutment portions 11c of the drive member 11 such that the first and second springs SP1 and SP2 alternate with each other along the circumferential direction of the damper device 10. Further, each of the spring abutment portions 12c of the intermediate member 12 is located between and in abutment with ends of the first and second springs SP1 and SP2 that are paired (to act in series) by being disposed between adjacent ones of the spring abutment portions Ile. Thus, with the damper device 10 mounted, one end of each of the first springs SP1 is in abutment with a corresponding one of the spring abutment portions 11c of the drive member 11, and the other end of each of the first springs SP1 is in abutment with a corresponding one of the spring abutment portions 12c of the intermediate member 12. Likewise, with the damper device 10 mounted, one end of each of the second springs SP2 is in abutment with a corresponding one of the spring abutment portions 12c of the intermediate member 12, and the other end of each of the second springs SP2 is in abutment with a corresponding one of the spring abutment portions 11c of the drive member 11.

On the other hand, as can be seen from FIG. 2, each of the spring supporting portions 16a of the first driven plate 16 supports (guides), from radially inside, a side portion of a corresponding pair of the first and second springs SP1 and SP2 on the near side to the turbine runner 5. Likewise, each of the spring supporting portions 16b supports (guides), from radially outside, a side portion of a corresponding pair of the first and second springs SP1 and SP2 on the near side to the turbine runner 5. Further, as can be seen from FIG. 2, each of the spring supporting portions 17a of the second driven plate 17 supports (guides), from radially inside, a side portion of a corresponding pair of the first and second springs SP1 and SP2 on the near side to the lockup piston 80. Likewise, each of the spring supporting portions 17b supports (guides), from radially outside, a side portion of a corresponding pair of the first and second springs SP1 and SP2 on the near side to the lockup piston 80.

Further, with the damper device 10 mounted, as with the spring abutment portions 11c of the drive member 11, each of the spring abutment portions 16c and each of the spring abutment portions 17c of the driven member 15 is located between and in abutment with ends of the first and second springs SP1 and SP2 that are not paired (not to act in series). Thus, with the damper device 10 mounted, the one end of each of the first springs SP1 is also in abutment with corresponding spring abutment portions 16c and 17c of the driven member 15, and the other end of each of the second springs SP2 is also in abutment with corresponding spring abutment portions 16c and 17c of the driven member 15. As a result, the driven member 15 is coupled to the drive member 11 via the multiple first springs SP1, the intermediate member 12, and the multiple second springs SP2, and the first and second springs SP1 and SP2 in each pair are coupled in series via the spring abutment portion 12c of the intermediate member 12 between the drive member 11 and the driven member 15. It is noted that, according to the present embodiment, a distance from the axis of the starting apparatus 1 and the damper device 10 to the axis of each of the first springs SP1 is equal to a distance from the axis of the starting apparatus 1 and the like to the axis of each of the second springs SP2.

Further, the damper device 10 according to the present embodiment includes the following: a first stopper that restricts relative rotation between the intermediate member 12 and the driven member 15 and that restricts deflection of the second springs SP2; and a second stopper that restricts relative rotation between the drive member 11 and the driven member 15. The first stopper is structured to restrict relative rotation between the intermediate member 12 and the driven member 15 when torque transmitted from the engine EG to the drive member 11 reaches a predetermined torque (a first threshold) T1 that is smaller than a torque T2 (a second threshold) corresponding to a maximum torsional angle of the damper device 10. On the other hand, the second stopper is structured to restrict relative rotation between the drive member 11 and the driven member 15 when the torque transmitted to the drive member 11 reaches the torque T2 corresponding to the maximum torsional angle. Thus, the damper device 10 has two levels (two stages) of damping characteristics. Alternatively, the first stopper may be structured to restrict relative rotation between the drive member 11 and the intermediate member 12 and restrict deflection of the first springs SP1. Alternatively, the damper device 10 may include both a stopper that restricts relative rotation between the drive member 11 and the intermediate member 12 and that restricts deflection of the first springs SRI, and a stopper that restricts relative rotation between the intermediate member 12 and the driven member 15 and that restricts deflection of the second springs SP2.

The vibration damping device 20 is coupled to the driven member 15 of the damper device 10 and is located in a fluid transmission chamber 9 filled with hydraulic oil. As illustrated in FIG. 2 to FIG. 6, the vibration damping device 20 includes the following: the first driven plate 16 serving as a supporting member; multiple (according to the present embodiment, for example, three) weight bodies 22, serving as a restoring-force generating member, coupled to the first driven plate 16 in such a manner as to transmit and receive torque to and from the first driven plate 16; and a single annular inertial mass body 23 coupled to each weight body 22.

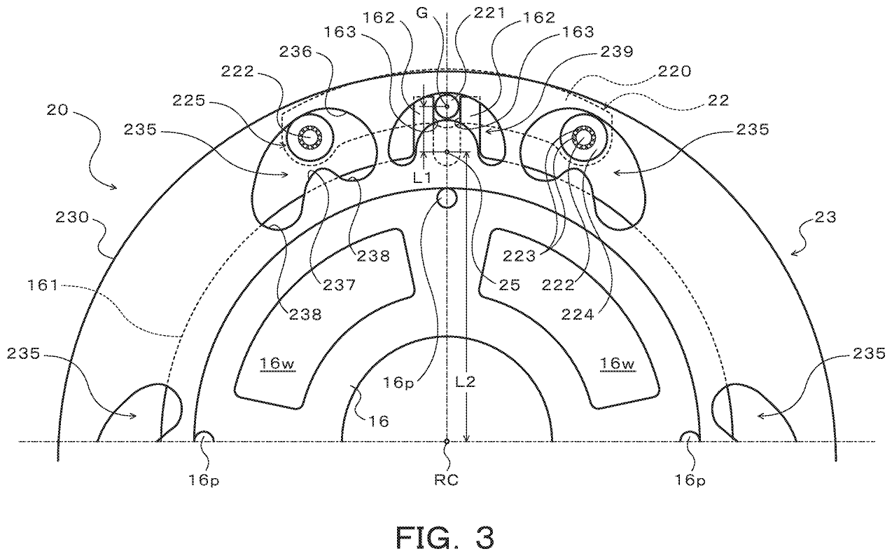

As illustrated in FIG. 3, the first driven plate 16 has multiple (according to the present embodiment, for example, six) protrusions 162 that protrude outward from its outer circumferential surface 161 in the radial direction and that are spaced from each other in pairs in the circumferential direction. Inner surfaces 163 of the two protrusions 162 in each pair each extend in the radial direction of the first driven plate 16, face each other with a clearance therebetween in the circumferential direction of the first driven plate 16, and each serve as a torque transmission surface for exchanging torque with the weight body 22.

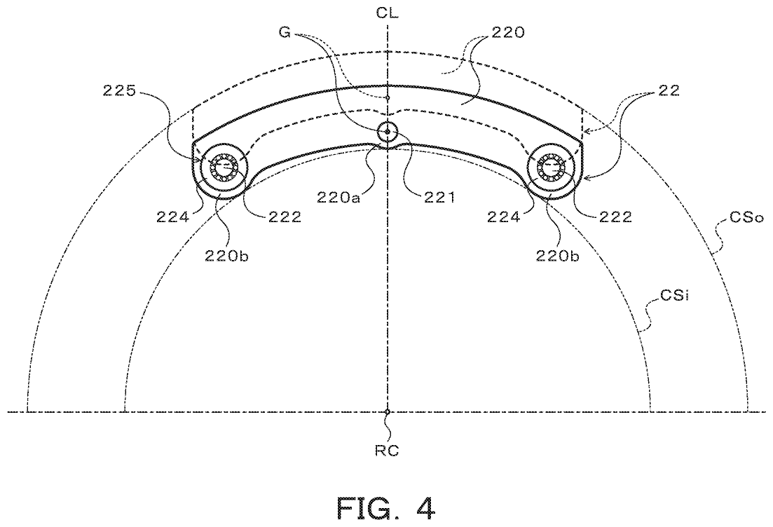

As illustrated in FIG. 3 to FIG. 6, each weight body 22 has two plate members (mass bodies) 220 that are identical in shape to each other, a first coupling shaft 221, and two second coupling shafts 222. As illustrated in FIG. 3, each of the plate members 220 is made of a metal plate in the form of a symmetrical arc planar shape, and the two plate members 220 are coupled together by the first coupling shaft 221 and the two second coupling shafts 222 in such a manner as to face each other in the axial direction of the first driven plate 16. As illustrated in FIG. 4, each of the plate members 220 has an outer circumferential surface formed by a cylindrical surface CSo, and a concavely-curved inner circumferential surface. Further, the inner circumferential surface of each of the plate members 220 includes the following: a protrusion 220a that protrudes in a direction away from the outer circumferential surface at a middle portion of the plate member 220 in its width direction, i.e., in the vicinity of the first coupling shaft 221; and two protrusions 220b that each protrudes in a direction away from the outer circumferential surface at one end or at the other end of the plate member 220. According to the present embodiment, each of the protrusions 220a and 220b has a surface shaped like a cylindrical surface, and the surfaces of the protrusions 220a and 220b are in contact with a cylindrical surface CSi as illustrated in FIG. 4.

The first coupling shaft 221 is shaped in a solid (or hollow) circular rod and, as illustrated in FIG. 3, is fixed (coupled) to the two plate members 220 such that the axis of the first coupling shaft 221 passes through a gravity center G of the weight body 22 that lies on a center line CL (a straight line passing through a rotation center RC of the first driven plate 16 with the weight body 22 mounted, refer to FIG. 4) of the weight body 22 (the plate members 220) in its width direction (in the circumferential direction of the first driven plate, etc.). The first coupling shaft 221 has an outside diameter smaller than both a clearance between the two protrusions 162 (the inner surfaces 163) of the first driven plate 16 that are paired and the length of the inner surfaces 163 in the radial direction. The first coupling shaft 221 is slidably disposed between the pair of protrusions 162 in such a manner to abut with one of the inner surfaces 163 of the both. Thus, each weight body 22 is coupled movably in the radial direction relative to the first driven plate 16 serving as a supporting member so as to form a sliding pair with the first driven plate 16. Further, the first coupling shaft 221 is abuttable with either of the inner surfaces 163 of the pair of the protrusions 162 and thereby serves as a torque transmission portion for exchanging torque with the first driven plate 16. The first coupling shaft 221 may be configured either to rotatably support a cylindrical outer ring via multiple rollers or balls (rolling elements) or to rotatably support the outer ring without via the rolling elements.

On the other hand, the two second coupling shafts 222 of each weight body 22 are shaped like a solid (or hollow) circular rod and, as illustrated in FIG. 3, are fixed to one ends or the other ends of the two plate members 220 in such a manner as to be symmetric with respect to the center line CL of the weight body 22 (the plate members 220) passing through the gravity center G. That is, the axes of the two second coupling shafts 222 fixed to the two plate members 220 are symmetric with respect to the center line CL of the weight body 22 in its width direction. Further, as illustrated in FIG. 3 and FIG. 6, the second coupling shaft 222 rotatably supports a cylindrical outer ring (roller) 224 via multiple rollers (rolling elements) 223. The second coupling shaft 222, the rollers 223, and the outer ring 224 structure a guidable portion 225 of the weight body 22. According to the present embodiment, as illustrated in FIG. 4, since the protrusions 220b are formed at both ends of each of the plate members 220, the rim of the outer ring 224 does not lie beyond the outer edges of the plate members 220. Multiple balls, instead of the rollers 223, may be disposed between the second coupling shaft 222 and the outer ring 224, or the rollers and balls may be omitted.

The inertial mass body 23 includes two annular members 230 made of metal plates, and the weight of the inertial mass body 23 (the two annular members 230) is set sufficiently greater than the weight of one weight body 22. As illustrated in FIG. 3 and FIG. 6, each of the annular members 230 has multiple (according to the present embodiment, for example, six) guide portions 235 that are spaced from each other in pairs in the circumferential direction. Each of the guide portions 235 is an opening extending in the form of a bow and guides the guidable portion 225 of a corresponding one of the weight bodies 22. According to the present embodiment, the two guide portions 235 in each pair are formed in the annular member 230 symmetrically with respect to a straight line (a straight that divides the annular member 230 into as many equal parts as there are weight bodies 22) that extends in the radial direction to divide the annular member 230 into three equal parts around its center.

Each of the guide portions 235 includes, as illustrated in FIG. 3, the following: a concavely-curved guide surface 236 serving as a rolling contact surface for the outer ring 224 that structures the guidable portion 225 of the weight body 22; a concavely-curved support surface 237 that is located closer to the inner perimeter of the annular member 230 (closer to the center of the annular member 230) than the guide surface 236 and that faces the guide surface 236; and two stopper surfaces 238 that connect with both of the guide surface 236 and the support surface 237 at their both sides. The guide surface 236 is formed such that when the outer ring 224 rolls on the guide surface 236 along with rotation of the first driven plate 16, the gravity center G of the weight body 22 swings relative to (moves toward or away from) the rotation center RC of the first driven plate 16 along the radial direction and swings about an imaginary axis 25, which is determined to have a position fixed relative to the inertial mass body 23, while keeping an interaxial distance L1 to the imaginary axis 25 constant. The imaginary axis 25 is a straight line normal to the annular member 230 and passing through a point that lies on the straight line (the straight line that divides the annular member 230 into as many equal parts as there are weight bodies 22) extending in the radial direction to divide the annular member 230 into three equal parts around its center and that is separated from the center of the annular member 230 (the rotation center RC) by a predetermined interaxial distance L2. The support surface 237 is a concavely-curved surface and faces the guide surface 236 with a predetermined clearance therebetween that is slightly greater than the outside diameter of the outer ring 224. The stopper surfaces 238 are, for example, concavely-curved surfaces extending in an arc.

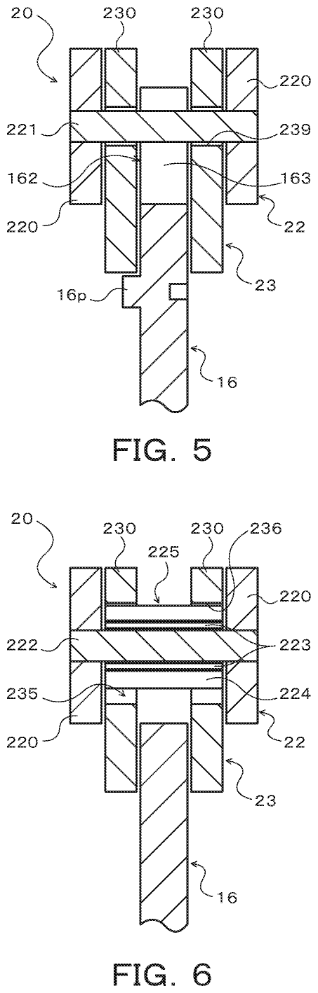

As illustrated in FIG. 6, the two annular members 230 of the inertial mass body 23 are disposed coaxially with the first driven plate 16, one on each side of the first driven plate 16 in the axial direction such that their corresponding guide portions 235 face each other in the axial direction of the annular members 230, and then are coupled together by a coupling member that is not illustrated. Further, the inner circumferential surface of each of the annular members 230 is supported by multiple projections 16p (refer to FIG. 3 and FIG. 5) that are each provided to the first driven plate 16 and that extend in the axial direction. Thus, each of the annular members 230 (the inertial mass body 23) is rotatably supported about the rotation center RC by the first driven plate 16 so as to form a revolute pair with the first driven plate 16.

The two plate members 220 of the weight body 22 are disposed to face each other in the axial direction across the corresponding pair of the protrusions 162 of the first driven plate 16 and the two annular members 230, and are coupled together by the first and second coupling shafts 221 and 222. As illustrated in FIG. 3 and FIG. 5, each of the annular members 230 of the inertial mass body 23 has an opening 239 formed therein and extending in an arc, and the first coupling shaft 221 of the weight body 22 is inserted through the openings 239. According to the present embodiment, the inner surface of the opening 239 is formed in such a manner as not to contact with the first coupling shaft 221. Further, as illustrated in FIG. 6, each of the second coupling shafts 222 that couple together the two plate members 220 goes through the corresponding guide portion 235 of the two annular members 230, and each of the outer rings 224 is disposed inside the corresponding guide portion 235 of the two annular members 230.

As described above, in the vibration damping device 20, the weight bodies 22 and the first driven plate 16 form a sliding pair, and the first driven plate 16 and the inertial mass body 23 form a revolute pair. Further, the outer rings 224 of each weight body 22 are rollable on the guide surfaces 236 of the corresponding guide portions 235, so that each weight body 22 and the inertial mass body 23 form a sliding pair. Thus, the first driven plate 16, the weight bodies 22, and the inertial mass body 23 having the guide portions 235 structure a slider-crank mechanism (a double slider-crank chain). In an equilibrium state of the vibration damping device 20, the gravity center G of each weight body 22 lies on a straight line passing through the corresponding imaginary axis 25 and the rotation center RC (refer to FIG. 3). Further, according to the present embodiment, the first driven plate 16 serving as a supporting member is disposed offset from each weight body 22 and the inertial mass body 23 in the axial direction.

Next, the operation of the starting apparatus 1 including the vibration damping device 20 is described. In the starting apparatus 1, with the lockup clutch 8 releasing the lockup, as can be seen from FIG. 1, torque (power) from the engine EG serving as a motor is transmitted to the input shaft IS of the transmission TM through a passage including the front cover 3, the pump impeller 4, the turbine runner 5, and the damper hub 7. On the other hand, when the lockup clutch 8 perfoms the lockup, as can be seen from FIG. 1, the torque (power) from the engine EG is transmitted to the input shaft IS of the transmission TM through a passage including the front cover 3, the lockup clutch 8, the drive member 11, the first spring SP1, the intermediate member 12, the second spring SP2, the driven member 15, and the damper hub 7.

With the lockup clutch 8 performing the lockup, when the drive member 11 that is coupled to the front cover 3 by the lockup clutch 8 rotates along with rotation of the engine EG, the first and second springs SP1 and SP2 act in series between the drive member 11 and the driven member 15 via the intermediate member 12 until the torque transmitted to the drive member 11 reaches the torque T1. Thus, the torque transmitted to the front cover 3 from the engine EG is transmitted to the input shaft IS of the transmission TM while fluctuations in the torque from the engine EG are damped (absorbed) by the first and second springs SP1 and SP2 of the damper device 10. Further, when the torque transmitted to the drive member 11 becomes equal to or greater than the torque T1, the fluctuations in the torque from the engine EG are damped. (absorbed) by the first spring SP1 of the damper device 10 until the torque reaches the torque T2.

Moreover, in the starting apparatus 1, when the damper device 10 that is coupled to the front cover 3 by the lockup clutch 8 performing the lockup rotates with the front cover 3, the first driven plate 16 (the driven member 15) of the damper device 10 also rotates about the axis of the starting apparatus 1 in the same direction as the front cover 3. When the first driven plate 16 rotates, the first coupling shaft 221 of each weight body 22 comes in contact with any one of the inner surfaces 163 of the corresponding pair of the protrusions 162, depending on which direction the first driven plate 16 rotates. The outer ring 224 supported by the second coupling shaft 222 of the weight body 22 is pressed against the guide surface 236 of the corresponding guide portion 235 of the inertial mass body 23 by the action of centrifugal force on the weight body 22 and rolls on the guide surface 236 toward one end of the guide portion 235 by receiving a force caused by the moment of inertia (how hard it is to rotate) of the inertial mass body 23.

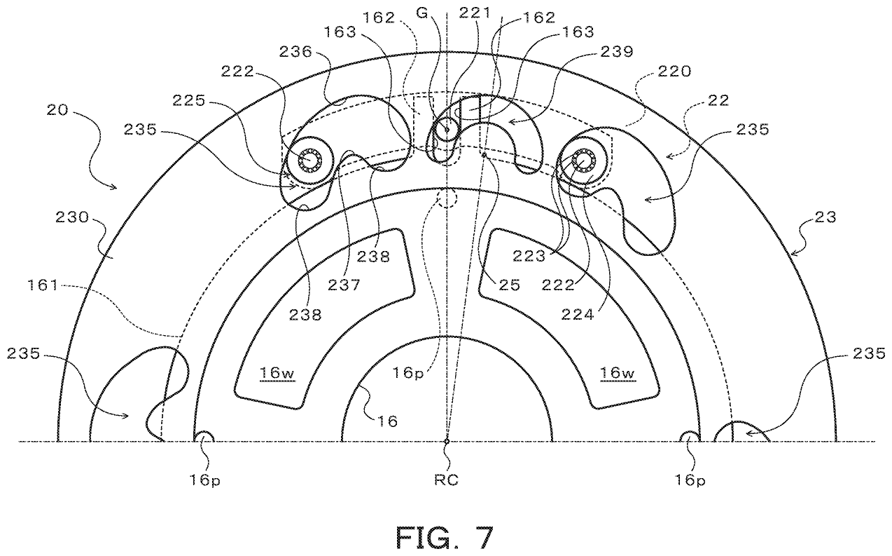

Thus, as illustrated in FIG. 7, when the first driven plate 16 rotates in one direction (for example, counterclockwise in the drawing) about the rotation center RC, each weight body 22 (the gravity center G) moves in the radial direction of the first driven plate 16 toward the rotation center RC while being restricted in rotation about its own axis by being guided by the two (the pair of) guidable portions 225 (the outer rings 224 and the second coupling shafts 222) and the two (the pair of) guide portions 235. Further, since the guidable portions 225 are guided by the guide portions 235, the gravity center G of each weight body 22 rotates about the imaginary axis 25 with the interaxial distance L1 kept constant, and accordingly the inertial mass body 23 rotates around the rotation center RC in a direction opposite to that of the first driven plate 16.

Further, a component force of the centrifugal force acting on the gravity center G of each weight body 22 is transmitted to the inertial mass body 23 via the guidable portions 225 (the outer rings 224) and the guide surfaces 236 of the guide portions 235, and serves as a restoring force for returning the inertial mass body 23 to a position corresponding to the equilibrium state. At the limits of a range of swing of the weight body 22 that is determined according to the amplitude (vibration level) of vibration transmitted from the engine EG to the first driven plate 16 (the driven member 15), the restoring force overcomes a force (the moment of inertia) that causes the inertial mass body 23 to continue rotating in the direction in which it has been rotating. Thus, each weight body 22 moves in a direction opposite to the direction in which it has been moving, away from the rotation center RC along the radial direction of the first driven plate 16, while being restricted in rotation about its own axis by being guided by the pair of guidable portions 225 and the pair of guide portions 235. Further, by the action of the restoring force from each weight body 22, i.e., the component force of the centrifugal force, the inertial mass body 23 rotates synchronously with each weight body 22 about the rotation center RC in a direction opposite to the direction in which it has been rotating, toward the position corresponding to the equilibrium state.

When the inertial mass body 23 reaches the position corresponding to the equilibrium state during rotation of the first driven plate 16 in the one direction, the inertial mass body 23 tends to continue rotating in the same direction due to the moment of inertia (how hard it is to stop). Further, the outer ring 224 of the weight body 22 receives a force caused by the moment of inertia (how hard it is to stop) of the inertial mass body 23, thereby rolling on the guide surface 236 toward the other end of the guide portion 235. Thus, each weight body 22 (the gravity center G) moves again in the radial direction of the first driven plate 16 toward the rotation center RC while being restricted in rotation about its own axis by being guided by the pair of guidable portions 225 and the pair of guide portions 235. Furthermore, since the guidable portions 225 are guided by the guide portions 235, the gravity center G of each weight body 22 rotates about the imaginary axis 25 with the interaxial distance L1 kept constant, and accordingly the inertial mass body 23 rotates about the rotation center RC in the same direction as and relative to the first driven plate 16.

Also in this case, the component force of the centrifugal force acting on the gravity center G of each weight body 22 is transmitted as the restoring force to the inertial mass body 23 via the guidable portions 225 and the guide surfaces 236 of the guide portions 235, and overcomes, at the limits of the swing range, a force (the moment of inertia) that causes the inertial mass body 23 to continue rotating in the direction in which it has been rotating. Thus, each weight body 22 moves in the radial direction of the first driven plate 16 away from the rotation center RC while being restricted in rotation about its own axis by being guided by the pair of guidable portions 225 and the pair of guide portions 235. Further, by the action of the restoring force from each weight body 22, i.e., the component force of the centrifugal force, the inertial mass body 23 rotates synchronously with each weight body 22 about the rotation center RC toward the position corresponding to the equilibrium state.

As described above, when the first driven plate 16 (the driven member 15) rotates in one direction, each weight body 22 serving as a restoring-force generating member of the vibration damping device 20 swings (reciprocates) relative to the rotation center RC along the radial direction of the first driven plate 16 within a swing range that has a center corresponding to an equilibrium state determined according to the amplitude (vibration level) of vibration transmitted from the engine EG to the driven member 15. Further, the component force of the centrifugal force acting on each weight body 22 is transmitted to the inertial mass body 23 via the guidable portions 225 and the guide portions 235, so that the inertial mass body 23 swings (reciprocates) about the rotation center RC in the direction opposite to that of the first driven plate 16 within a swing range that has a center corresponding to an equilibrium state determined according to the swing range of each weight body 22.

This allows the swinging inertial mass body 23 to supply the first driven plate 16, via the guide portions 235, the guidable portions 225, the weight bodies 22, the first coupling shafts 221, and the protrusions 162, with torque of opposite phase (inertia torque) to the fluctuating torque (vibration) transmitted from the engine EG to the drive member 11. Thus, by setting the specifications of the vibration damping device 20 such that it has an order corresponding to the order of vibration transmitted from the engine EG to the first driven plate 16 (excitation order: 1.5th order when the engine EG is a three-cylinder engine; second order when the engine EG is a four-cylinder engine), it is possible for the vibration damping device 20 to damp the vibration transmitted from the engine EG to the driven member 15 (the first driven plate 16) successfully, regardless of the rotation speed of the engine EG (the first driven plate 16).

Further, in the vibration damping device 20, each weight body 22 has the two (the pair of) guidable portions 225 that are spaced in its width direction (the circumferential direction of the first driven plate 16 and the like), and the movement of each weight body 22 is defined (restrained) by the two guidable portions 225 and their corresponding two (the pair of) guide portions 235 of the inertial mass body 23. This allows the pair of guidable portions 225 and the pair of guide portions 235 to restrict rotation of each weight body 22 about its own axis so as to suppress a decrease in the order of the vibration damping device 20 due to an increase in equivalent mass caused by rotation of the weight body 22 about its own axis, and also allows the weight body 22 to smoothly swing relative to the first driven plate 16 so as to suppress damping of the centrifugal force (its component force), acting on the weight body 22, to be used as a restoring force for swinging the inertial mass body 23. Further, by suppressing a decrease in the order of the vibration damping device 20 due to the rotation of the weight body 22 about its own axis, it is possible for the inertial mass body 23 to have a sufficient weight so as to provide a good vibration damping effect. In addition, defining (restraining) the movement of each weight body 22 by the pair of guidable portions 225 and the pair of guide portions 235 allows a reduction in friction force that is generated between the first coupling shaft 221 and the protrusions 162 of the first driven plate 16 during transmission and reception of torque between each weight body 22 and the first driven plate 16. This allows a further improvement in vibration damping performance of the vibration damping device 20 including the weight bodies 22 that swing in the radial direction of the first driven plate 16 along with rotation of the first driven plate 16.

Further, in each weight body 22, the two guidable portions 225 are disposed symmetrically with respect to the center line CL of the plate member 220 in its width direction (its circumferential direction), and the first coupling shaft 221 serving as a torque transmission portion is located on the center line CL. This allows the weight body 22 to smoothly swing with rotation of the weight body 22 restricted about its own axis using the pair of guide portions 235 and the pair of guidable portions 225 while reducing the friction force generated between the first coupling shaft 221 and the protrusions 162, thus successfully reducing damping of the centrifugal force acting on the weight body 22. However, when each weight body 22 is coupled to the first driven plate 16 in such a manner as to transmit and receive torque therebetween via the first coupling shaft 221 and the pair of protrusions 162, it is possible to restrict the rotation of each weight body 22 about its own axis by the first coupling shaft 221, the protrusions 162, and one set of the guidable portion 225 and the guide portion 235. Therefore, each weight body 22 may be provided with one guidable portion 225 and one guide portion 235. Alternatively, each weight body 22 may be provided with three or more guidable portions 225 and three or more guide portions 235.

Further, in the vibration damping device 20, the first driven plate 16 serving as a supporting member is disposed offset from each weight body 22 and the inertial mass body 23 in the axial direction. This eliminates interference of each weight body 22 and the inertial mass body 23 with the first driven plate 16 in the radial direction. Thus, this provides mounting space for each weight body 22 and the inertial mass body 23 more successfully to further increase the centrifugal force acting on each weight body 22 and to further increase the moment of inertia of the inertial mass body 23.

Further, in the vibration damping device 20, the inertial mass body 23 includes the two annular members 230 that are disposed to face each other in the axial direction of the first driven plate 16, and the first driven plate 16 is disposed between the two annular members 230 in the axial direction. This still further increases the moment of inertia of the inertial mass body 23 so as to still further improve the vibration damping performance of the vibration damping device 20.

Further, the center of curvature of the cylindrical surface CSi, which is a curved surface in contact with the protrusions 220a and 220b formed on the inner circumferential surface of the plate member 220 of each weight body 22, coincides with the rotation center RC when the weight body 22 reaches an innermost position (refer to a continuous line in FIG. 4) of the swing range in the radial direction, as illustrated in FIG. 4. This successfully suppresses interference of each of the swinging weight bodies 22 with members located inward of the weight body 22 in the radial direction and also brings the inner circumferential surface of the weight body 22 near to the rotation center RC, thus successfully providing the weight of the weight body 22. Alternatively, the inner circumferential surface of the plate member 220 of each weight body 22 may be shaped in a concave cylindrical surface, and in this case, the center of curvature of the inner circumferential surface of the plate member 220 may coincide with the rotation center RC when the weight body 22 reaches the innermost position of the swing range in the radial direction. Further, the center of curvature of the outer circumferential surface of the plate member 220 of each weight body 22, i.e., the cylindrical surface CSo coincides with the rotation center RC when the weight body 22 reaches an outermost position (refer to a dashed line in FIG. 4) of the swing range in the radial direction, as illustrated in FIG. 4. This adequately provides the swing range of each weight body 22.

Further, in the vibration damping device 20, the guidable portion 225 is provided to the weight body 22, and the guide portion 235 is formed to the inertial mass body 23. This causes the gravity center G of the weight body 22 to be at a further distance from the rotation center RC so as to suppress a reduction in the centrifugal force that acts on the weight body 22, i.e., the restoring force that acts on the inertial mass body 23, thus successfully providing vibration damping performance. Alternatively, in the vibration damping device 20, the guide portion 235 may be formed to the weight body 22, and the guidable portion 225 may be formed to the inertial mass body 23.

Further, each guidable portion 225 includes the second coupling shaft 222 supported by the weight body 22, i.e., the two plate members 220, and the outer ring 224 rotatably supported by the second coupling shaft 222, and each guide portion 235 includes the concavely-curved guide surface 236 on which the outer ring 224 rolls. This allows the weight body 22 to more smoothly swing so as to suppress thumping of the centrifugal three acting on the weight body 22 very successfully.

Further, in the vibration damping device 20, the first driven plate 16 has, as a torque transmission surface for exchanging torque with the weight bodies 22, the pair of inner surfaces 163 that each extend in the radial direction and that face each other with a clearance therebetween in the circumferential direction of the first driven plate 16. Further, each weight body 22 has, as a torque transmission portion for exchanging torque with the first driven plate 16, the first coupling shaft 221 that is disposed between the pair of inner surfaces 163 (protrusions 162) of the first driven plate 16 in such a manner as to abut with one of the inner surfaces 163. This allows the first driven plate 16 and the weight bodies 22 to be coupled together in such a manner as to transmit torque therebetween while reducing the friction force generated between their coupling portions, i.e., between the inner surface 163 and the first coupling shaft 221.

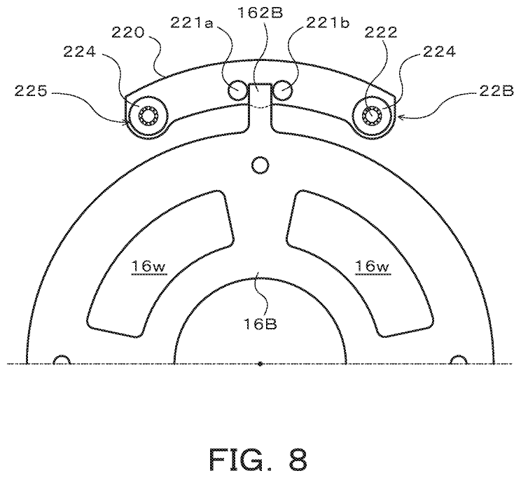

Alternatively, as illustrated in FIG. 8, two first coupling shafts (a first torque transmission portion) 221a and 221b may be disposed in a weight body 22B with a clearance therebetween in the width direction (the circumferential direction) of the weight body 22B (the plate member 220), and a first driven plate 16B serving as a supporting member may have protrusion (a second torque transmission portion) 162B formed thereto that extends in the radial direction and that is disposed between the two first coupling shafts 221a and 221b. In the example of FIG. 8, the protrusion 162B has a width slightly smaller than the clearance between the first coupling shafts 221a and 221h and is disposed slidably between the first coupling shafts 221a and 221b of the weight body 22B in such a manner as to abut with one of the first coupling shafts 221a and 221b. Using this structure also allows the first driven plate 16 and the weight bodies 22 to be coupled together in such a manner as to transmit torque therebetween while reducing the friction force generated between their coupling portions, i.e., between the protrusion 162B and the first coupling shaft 221a or 221b.

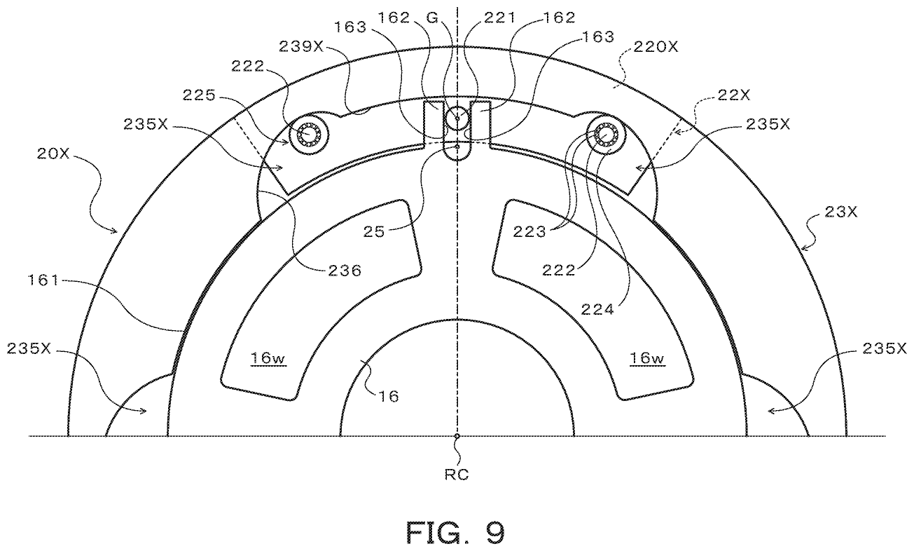

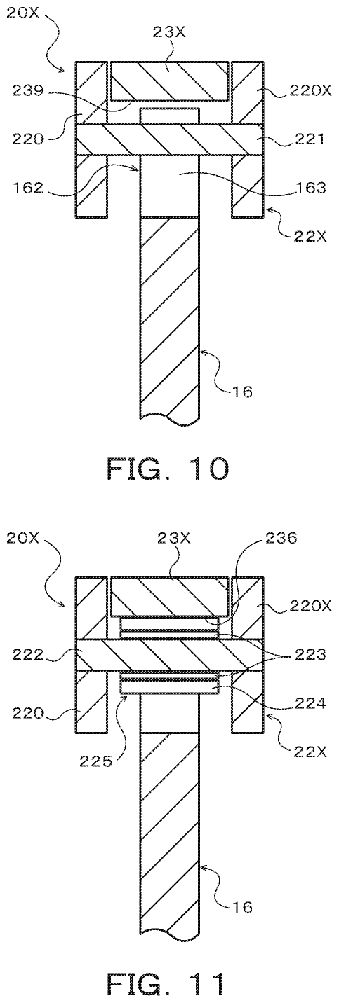

FIG. 9 is an enlarged view illustrating another vibration damping device 20X according to the present disclosure. FIG. 10 and FIG. 11 are enlarged cross-sectional views of main parts of the vibration damping device 20X. Elements of the vibration damping device 20X that are the same as those of the vibration damping device 20 described above are denoted by the same reference characters, and their redundant description will be omitted.

The vibration damping device 20X illustrated in FIG. 9 to FIG. 11 uses a unitary annular member as an inertial mass body 23X. Further, guide portions 235X of the inertial mass body 23X are cut-off portions having only concavely-curved guide surfaces 236 and are equivalent to what is obtained by omitting the support surfaces 237 and the stopper surfaces 238 from the guide portions 235 of the vibration damping device 20. Furthermore, a concave portion 239X is formed on the inner circumferential surface of the inertial mass body 23X and is located between a pair of two guide portions 235X in the circumferential direction. The inertial mass body 23X is disposed between two plate members 220X of a weight body 22X in the axial direction in such a manner as to surround the first driven plate 16, and the inner circumferential surface (portions other than the guide portion 235X and the concave portion 239X) of the inertial mass body 23X is rotatably supported by the outer circumferential surface 161 of the first driven plate 16. Each of the protrusions 162 of the first driven plate 16 and the first coupling shaft 221 of each weight body 22X are disposed inward of the concave portion 239X of the inertial mass body 23X in the radial direction.

Also in the vibration damping device 20X, the same effects as in the vibration damping device 20 described above are obtainable. Preferably, the inner circumferential surface of the plate member 220X of each weight body 22X may be formed such that the center of curvature thereof coincides with the rotation center RC when the weight body 22 reaches the innermost position (refer to a continuous line in FIG. 4) of the swing range in the radial direction. This successfully suppresses interference of each of the swinging weight bodies 22X with members located inward of the weight body 22X in the radial direction and also successfully provides the weight of the weight body 22. Further, it may be preferable that the outer circumferential surface of the plate member 220X of each weight body 22X be formed such that the center of curvature thereof coincides with the rotation center RC when the weight body 22 reaches the innermost position of the swing range in the radial direction. This adequately provides the swing range of each weight body 22X.

Although in the vibration damping device 20, 20X described above, the gravity center G of each weight body 22 swings about the imaginary axis 25 with the interaxial distance L1 kept constant, the present disclosure is not limited to this. That is, the vibration damping device 20, 20X may be structured such that a portion other than the gravity center of the weight body 22 swings about the imaginary axis 25 with an interaxial distance kept constant. Further, in the vibration damping device 20, 20X, the guide portion 235 for guiding the guidable portion 225 may be formed to move in an arc trajectory when the weight body 22 swings relative to the rotation center RC along the radial direction of the first driven plate 16.

Preferably, the vibration damping device 20, 20X is designed such that its order (the order of vibration to be most successfully damped by the vibration damping device 20, 20X, hereinafter referred to as “effective order q_{eff}”) is greater than the sum of an excitation order q_{tag} of the engine EG and an offset value Δq that is determined taking into account the influence of oil in the fluid transmission chamber 9. Experiments and analyses conducted by the present inventors have revealed that although the offset value Δq varies depending on the torque ratio and torque capacity of the starting apparatus 1 (the fluid transmission device) and the capacity of the fluid transmission chamber 9, it falls within the following range: 0.05×q_{tag}<Δq≤0.20× q_{tag}. Further, it is preferable that the vibration damping device 20, 20X be designed such that a reference order q_{ref} is greater than the excitation order q_{tag}. The reference order q_{ref} is a convergence value of the effective order q_{eff} when the amplitude of vibration of input torque transmitted to the driven member 15 (the first driven plate 16) decreases. In this case, the vibration damping device 20, 20X may be structured to satisfy the following: 1.00×qtag<qref≤1.03×qtag, more preferably, to satisfy the following: 1.01×qtag≤qref≤1.02×qtag. Further, the vibration damping device 20, 20X may be structured such that the effective order q_{eff} increases with an increase in the amplitude of vibration of input torque transmitted from the engine EG to the driven member 15 (the first driven plate 16). In this case, the difference between the effective order q_{ref} when the amplitude of vibration of the input torque and the excitation order q_{tag} of the engine EG may be either less than 50% of the excitation order or less than 20% of the excitation order. Furthermore, the interaxial distances L1 and L2 may satisfy the following: L1/(L1+L2)≥α+β·n, where “n” is the number of cylinders in the engine EG, and “α” and “β” are predetermined constants.

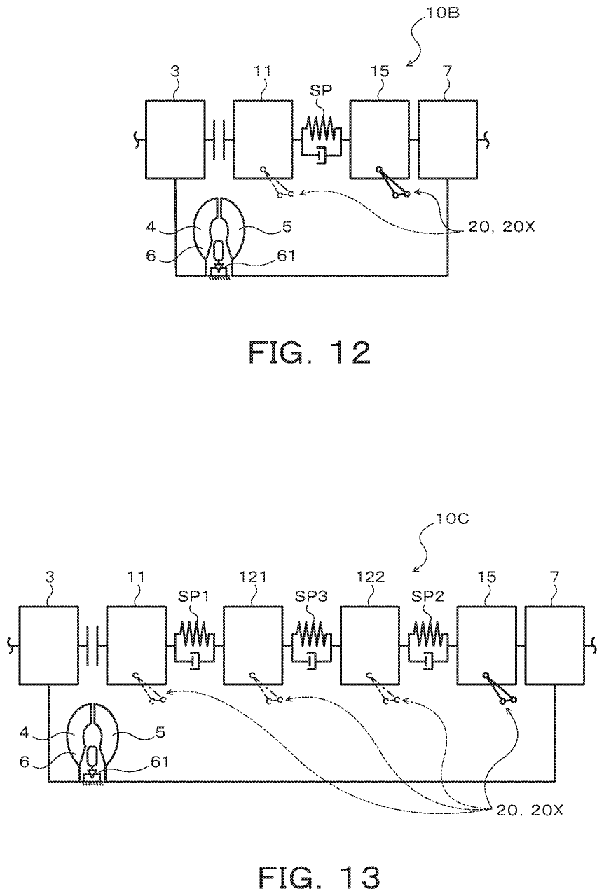

Further, the vibration damping device 20, 20X may be coupled either to the intermediate member 12 of the damper device 10 or to the drive member (an input element) 11 (refer to long dashed double-short dashed lines in FIG. 1). The vibration damping device 20, 20X may be used in a damper device 10B illustrated in FIG. 12. The damper device 10B in FIG. 12 is equivalent to what is made by omitting the intermediate member 12 from the damper device 10, includes, as rotating elements, the drive member (an input element) 11 and the driven member 15 (an output element), and includes, as a torque transmission element, a spring SP disposed between the drive member 11 and the driven member 15. In this case, the vibration damping device 20, 20X may be coupled either to the driven member 15 of the damper device 10B as illustrated, or to the drive member 11 as indicated by a long dashed double-short dashed line in the drawing.

The vibration damping device 20, 20X may be used in a damper device 10C illustrated in FIG. 13. The damper device 10C illustrated in FIG. 13 includes, as rotating elements, a drive member (an input element) 11, a first intermediate member (a first intermediate element) 121, a second intermediate member (a second intermediate element) 122, and a driven member (an output element) 15, and includes, as torque transmission elements, a first spring SP1 disposed between the drive member 11 and the first intermediate member 121, a second springs SP2 disposed between the second intermediate member 122 and the driven member 15, and a third spring SP3 disposed between the first intermediate member 121 and the second intermediate member 122. In this case, the vibration damping device 20, 20X may be coupled either to the driven member 15 of the damper device 10C as illustrated, or to one of the first intermediate member 121, the second intermediate member 122, and the drive member 11 as indicated by long dashed double-short dashed lines in the drawing. In any case, by coupling the vibration damping device 20, 20X to the rotating element of the damper device 10, 10B, 10C, it is possible to damp vibrations very successfully using both the damper device 10 to 10C and the vibration damping device 20, 20X.

As described above, a vibration damping device according to the present disclosure is a vibration damping device (20, 20X) including: a supporting member (16, 16B) that rotates integrally with a rotating element (11, 12, 121, 122, 15) that receives torque transmitted from an engine (EG) about a rotation center (RC) of the rotating element (11, 12, 121, 122, 15); a restoring-force generating member (22, 22B, 22X) that is coupled to the supporting member (16, 16B) to transmit and receive the torque to and from the supporting member (16, 16B) and that is swingable in a radial direction of the supporting member (16, 16B) along with rotation of the supporting member (16, 16B); an inertial mass body (23, 23X) that is coupled to the supporting member (16, 16B) via the restoring-force generating member (22, 22B, 22X) and that swings about the rotation center (RC), synchronously with the restoring-force generating member (22, 22B, 22X), along with rotation of the supporting member (16, 16B); two guidable portions (225) disposed in the restoring-force generating member (22, 22B, 22X) with a clearance therebetween in a circumferential direction of the rotating element (11, 12, 121, 122, 15); multiple guide portions (235, 235X) formed to the inertial mass body (23, 23X) and configured to guide corresponding ones of the guidable portions (225), when the supporting member (16, 16B) rotates, such that the restoring-force generating member (22, 22B, 22X) swings relative to the rotation center (RC) along the radial direction and such that the inertial mass body (23, 23X) swings about the rotation center (RC), a component force of centrifugal force acting on the restoring-force generating member (22, 22B, 22X) when the supporting member (16, 16B) rotates being transmitted from the guidable portions (225) to the guide portions (235, 235K); and a torque transmission portion (221, 221a, 221b) disposed in the restoring-force generating member (22, 22B, 22X) and located between the two guidable portions (225) in the circumferential direction so as to transmit and receive the torque to and from the supporting member (16, 16B).

In the vibration damping device according to the present disclosure, when the supporting member rotates integrally with the rotating element, the guidable portions formed to the restoring-force generating member are guided by the guide portions formed to the inertial mass body, thereby causing the restoring-force generating member to swing along the radial direction of the supporting member. Further, when the supporting member rotates integrally with the rotating element, the component force of the centrifugal force acting on the restoring-force generating member is transmitted to the inertial mass body via the guidable portions and the guide portions, and the guidable portions are guided by the guide portions, thereby causing the inertial mass body to swing about the rotation center synchronously with the restoring-force generating member. This makes it possible to supply torque of opposite phase (inertia torque) to fluctuating torque transmitted from the engine to the rotating element, to the supporting member via the restoring-force generating member (the torque transmission portion), thus damping the vibration of the rotating element successfully. Further, the restoring-force generating member includes the two guidable portions disposed with a clearance therebetween in the circumferential direction of the rotating element, and movement of the restoring-force generating member is defined (restrained) by the two (a pair of) guidable portions and their corresponding two (a pair of) guide portions of the inertial mass body. This causes the pair of guidable portions and the pair of guide portions to restrict rotation of the restoring-force generating member about its own axis so as to suppress a decrease in the order of the vibration damping device due to the rotation of the restoring-force generating member about its own axis, and also causes the restoring-force generating member to smoothly swing relative to the supporting member so as to suppress damping of the centrifugal force (its component force), acting on the restoring-force generating member, to be used as a restoring force for swinging the inertial mass body. Further, defining (restraining) the movement of the restoring-force generating member by the pair of guidable portions and the pair of guide portions allows a reduction in friction force that is generated at the torque transmission portion during transmission and reception of the torque between the restoring-force generating member and the supporting member. Thus, it is possible to further improve vibration damping performance of the vibration damping device including the restoring-force generating member that swings in the radial direction of the supporting member along with rotation of the supporting member.

Further, the two guidable portions (225) may be disposed symmetrically with respect to a center line (CL) of the restoring-force generating member (22, 22B, 22X) in the circumferential direction, and the torque transmission portion (221) may be located on the center line (CL). This allows the restoring-force generating member to smoothly swing while restricting its rotation about its own axis using the two (the pair of) guide portions and their corresponding guidable portions, and also makes it possible to further reduce the friction force generated at the torque transmission portion, thus successfully reducing damping of the centrifugal force acting on the restoring-force generating member.

Further, the restoring-force generating member (22, 22B, 22X) may include a mass body (220, 220X) shaped in a bilaterally symmetrical arc, and one of the guidable portions (225) may be provided at one end of the mass body (220, 220X) while the other of the guidable portions (225) may be provided at the other end of the mass body (220, 220X).

Further, the center of curvature of a curved surface (CSi) in contact with the inner circumferential surface of the restoring-force generating member (22, 22B, 22X) may coincide with the rotation center (RC) when the restoring-force generating member (22, 22B, 22X) reaches an innermost position of a swing range in the radial direction. This successfully suppresses interference of the swinging restoring-force generating member with members located inward of the restoring-force generating member in the radial direction and also successfully provides the weight of the restoring-force generating member.

Further, the center of curvature of the outer circumferential surface. (CSo) of the restoring-force generating member (22, 22B, 22X) may coincide with the rotation center (RC) when the restoring-force generating member (22, 22B, 22X) reaches an outermost position of the swing range in the radial direction. This adequately provides the swing range of the restoring-force generating member.

Further, the guidable portions (225) may include a shaft portion (222) supported by the restoring-force generating member (22, 22B, 22X), and a roller (225) rotatably supported by the shaft portion (222), and the guide portions (235, 235X) may include a concavely-curved guide surface (236) on which the outer ring (224) rolls. This allows the restoring-force generating member to smoothly swing, thus reducing the damping of the centrifugal force acting on the restoring-force generating member very successfully.

Further, the supporting member (16) may have a pair of torque transmission surfaces (163) formed therein that each extend in the radial direction and that face each other with a clearance therebetween in a circumferential direction of the supporting member (16), and the torque transmission portion (221) of the restoring-force generating member (22, 22B, 22X) is disposed between the pair of torque transmission surfaces (163) of the supporting member (16) in such a manner as to abut with at least one of the pair of torque transmission surfaces (163). This allows the supporting member and the restoring-force generating member to be coupled together in such a manner as to transmit torque therebetween while reducing the friction force generated therebetween.

Further, the supporting member (16, 16B) may rotate coaxially and integrally with any of multiple rotating elements (11, 12, 121, 122, 15) of a damper device (10, 10B, 10C), the multiple rotating elements includes at least an input element (11) and an output element (15), and the damper device (10, 10B, 10C) has an elastic member (SP, SP1, SP2, SP3) for transmitting the torque between the input element (11) and the output element (15). By coupling the vibration damping device to the rotating element of the damper device in this way, it is possible to damp vibrations very successfully using both the damper device and the vibration damping device.

Further, the output element (15) of the damper device (10, 10B, 10C) may be operatively (directly or indirectly) coupled to an input shaft (IS) of a transmission (TM).

Another damper device according to the present disclosure includes: a supporting member that rotates integrally with a rotating element that receives torque transmitted from an engine about a rotation center of the rotating element; a restoring-force generating member that is coupled to the supporting member to transmit and receive the torque to and from the supporting member and that is swingable along a radial direction of the supporting member along with rotation of the supporting member; an inertial mass body that is coupled to the supporting member via the restoring-force generating member and that swings about the rotation center, synchronously with the restoring-force generating member, along with rotation of the supporting member; multiple guidable portions formed to the inertial mass body; two guide portions disposed in the restoring-force generating member with a clearance therebetween in a circumferential direction of the rotating element and configured to guide corresponding ones of the guidable portions, when the supporting member rotates, such that the restoring-force generating member swings relative to the rotation center along the radial direction and such that the inertial mass body swings about the rotation center, a component force of centrifugal force acting on the restoring-force generating member when the supporting member rotates being transmitted from the guidable portions to the multiple guide portions; and a torque transmission portion disposed in the restoring-force generating member and located between the two guide portions in the circumferential direction so as to transmit and receive the torque to and from the supporting member.

Also in the damper device, the pair of guidable portions and the pair of guide portions restrict rotation of the restoring-force generating member about its own axis so as to suppress a decrease in the order of the vibration damping device due to the rotation of the restoring-force generating member about its own axis, and the restoring-force generating member smoothly swings relative to the supporting member so as to suppress damping of the centrifugal force (its component force), acting on the restoring-force generating member, to be used as a restoring force for swinging the inertial mass body. Further, defining (restraining) the movement of the restoring-force generating member by the pair of guidable portions and the pair of guide portions allows a reduction in friction force that is generated at the torque transmission portion during transmission and reception of the torque between the restoring-force generating member and the supporting member. Thus, it is possible to further improve vibration damping performance of the vibration damping device including the restoring-force generating member that swings in the radial direction of the supporting member along with rotation of the supporting member.

The various aspects of the present disclosure are not limited at all to the embodiment described above, and various modifications are possible within the scope of the present disclosure. In addition, the embodiments of the are merely one specific example of the aspects described in the SUMMARY OF THE DISCLOSURE section and does not limit the elements described in the SUMMARY OF THE DISCLOSURE section.

### INDUSTRIAL APPLICABILITY

The various aspects of the present disclosure are usable, for example, in the field of manufacturing of vibration damping devices for damping the vibration of a rotating element.

1. A vibration damping device including:
a supporting member that rotates integrally with a rotating element that receives torque transmitted from an engine about a rotation center of the rotating element;
a restoring-force generating member that is coupled to the supporting member to transmit and receive the torque to and from the supporting member and that is swingable in a radial direction of the supporting member along with rotation of the supporting member; and
an inertial mass body that is coupled to the supporting member via the restoring-force generating member and that swings about the rotation center, synchronously with the restoring-force generating member, along with rotation of the supporting member, the vibration damping device comprising:
two guidable portions disposed in the restoring-force generating member with a clearance between the guidable portions in a circumferential direction of the rotating element;
a plurality of guide portions formed to the inertial mass body and configured to guide corresponding ones of the guidable portions, when the supporting member rotates, such that the restoring-force generating member swings relative to the rotation center along the radial direction and such that the inertial mass body swings about the rotation center, a component force of centrifugal force acting on the restoring-force generating member when the supporting member rotates being transmitted from the guidable portions to the plurality of guide portions; and
a torque transmission portion disposed in the restoring-force generating member and located between the two guidable portions in the circumferential direction so as to transmit and receive the torque to and from the supporting member.

2. The vibration damping device according to claim 1, wherein the two guidable portions are disposed symmetrically with respect to a center line of the restoring-force generating member in the circumferential direction, and the torque transmission portion is located on the center line.

3. The vibration damping device according to claim 1, wherein the restoring-force generating member includes a mass body shaped in a bilaterally symmetrical arc, and the guidable portions are provided at one end and another end of the mass body.

4. The vibration damping device according to claim 1, wherein a center of curvature of a curved surface in contact with an inner circumferential surface of the restoring-force generating member coincides with the rotation center when the restoring-force generating member reaches an innermost position of a swing range in the radial direction.

5. The vibration damping device according to claim 4, wherein a center of curvature of an outer circumferential surface of the restoring-force generating member coincides with the rotation center when the restoring-force generating member reaches an outermost position of the swing range in the radial direction.

6. The vibration damping device according to claim 1, wherein
the guidable portions include a shaft portion supported by the restoring-force generating member, and a roller rotatably supported by the shaft portion, and
the guide portions include a concavely-curved guide surface on which the roller rolls.

7. The vibration damping device according to claim 1, wherein
the supporting member has a pair of torque transmission surfaces formed to the supporting member, the pair of torque transmission surfaces each extending in the radial direction and facing each other with a clearance between the pair of torque transmission surfaces in a circumferential direction of the supporting member, and
the torque transmission portion of the restoring-force generating member is disposed between the pair of torque transmission surfaces of the supporting member in such a manner as to abut with at least one of the pair of torque transmission surfaces.

8. The vibration damping device according to claim 1, wherein
the supporting member rotates coaxially and integrally with any of a plurality of rotating elements of a damper device, the plurality of rotating elements including at least an input element and an output element, the damper device having an elastic member for transmitting the torque between the input element and the output element.

9. The vibration damping device according to claim 8, wherein the output element of the damper device is operatively coupled to an input shaft of a transmission.

10. A vibration damping device including:
a supporting member that rotates integrally with a rotating element that receives torque transmitted from an engine about a rotation center of the rotating element;
a restoring-force generating member that is coupled to the supporting member to transmit and receive the torque to and from the supporting member and that is swingable along a radial direction of the supporting member along with rotation of the supporting member; and
an inertial mass body that is coupled to the supporting member via the restoring-force generating member and that swings about the rotation center, synchronously with the restoring-force generating member, along with rotation of the supporting member, the vibration damping device comprising:
a plurality of guidable portions formed to the inertial mass body;
two guide portions disposed in the restoring-force generating member with a clearance between the two guide portions in a circumferential direction of the rotating element and configured to guide corresponding ones of the guidable portions, when the supporting member rotates, such that the restoring-force generating member swings relative to the rotation center along the radial direction and such that the inertial mass body swings about the rotation center, a component force of centrifugal force acting on the restoring-force generating member when the supporting member rotates being transmitted from the guidable portions to the plurality of guide portions; and
a torque transmission portion disposed in the restoring-force generating member and located between the two guide portions in the circumferential direction so as to transmit and receive the torque to and from the supporting member.
